(19) United States
(12) Patent Application Publication
(10) Pub. No.: US 2005/0162688 A1
(43) Pub. Date: Jul. 28, 2005

(54) Printing terminal, printing data outputting device, and computer and peripheral device using therefor

(76) Inventors: Yasushi Nakaoka, Nagano-ken (JP); Masanori Mukaiyama, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/918,207

(22) Filed: Aug. 12, 2004

(30) Foreign Application Priority Data
Aug. 12, 2003 (JP) 2003-291976
Oct. 3, 2003 (JP) 2003-345150
Oct. 3, 2003 (JP) 2003-345351

(51) Int. Cl. G06F 15/00

(52) U.S. Cl. 358/1.15; 358/1.13

(57) ABSTRACT

When the user PC 200 is connected to the printing terminal 300, a generic printer driver 240 is automatically installed thereon. The generic printer driver 240 transfers to the printing terminal 300 EMF data generated by a printing application 210 in its existing format. When it receives the EMF data, the printing terminal 300 converts it into RAW data that can be interpreted by a printer 400 through the work of a player 350 and a printer driver 360. The printer 400 performs printing based on the RAW data received from the printing terminal in this fashion. Using this construction, a printer installed in a public place or similar location can be used without the need to perform particular configuration operations or install a printer driver unique to the printer.

### BACKGROUND

The present invention relates to a technology that enables a printer to be easily used without a special configuration or the installation of a printer driver for that printer on the personal computer, as well as to a peripheral device and computer that are required by such technology. This peripheral device is a peripheral device that is connected locally to the computer. The present invention further relates to a technology that uninstalls from the computer the previously-installed software used to operate the peripheral device.

### RELATED ART

In recent years, as the use of notebook computers has become widespread, demand for printing at public locations such as airport lobbies and libraries has increased. Accordingly, the installation of printers capable of being used by large numbers of persons has been desired (see, for example, Japanese Patent Laid-Open No. 2002-196898).

Furthermore, where the user of a personal computer (hereinafter ‘PC’) uses a peripheral device such as a printing device or a CD-ROM drive, such device is locally connected to the PC. In order to use such a peripheral device, the user installs the device driver onto the PC from a CD-ROM or the like. When the CD-ROM is loaded into the CD-ROM drive, the driver is automatically installed via the so-called autorun function.

The PC stores the installed driver on its hard disk. Where the PC is connected to a peripheral device through a USB port, for example, the driver stored on the hard disk is loaded and run in a memory area. Where the connection to the peripheral device is terminated, the memory area in which the driver is loaded is released for use by other software, but the driver itself remains on the hard disk until an uninstall command is given by the user.

This type of technology is disclosed in Japanese Patent Laid-Open No. 2003-114799A and Japanese Patent Laid-Open No. 2003-131827A.

However, even where one or more printers are installed in the type of location described above, a printer driver unique to each printer model must be installed on the PC in advance. As a result, the user must obtain over the Internet or from a CD-ROM a printer driver corresponding to each printer to be used, which is troublesome and time-consuming.

In recent years, peripheral devices such as printers have been installed in places other than the home and workplace, i.e., in public areas such as libraries, for example, where users who bring and use their own computers may use them. In order to ensure the convenience of users in such an environment, the provision of an environment is desired in which the drivers for such peripheral devices can be easily installed and in which a peripheral device can be used without the user having to connect and re-connect his computer with the peripheral device many times. In the conventional art, a complex procedure is required in which the user borrows a CD-ROM containing the driver, connects the CD-ROM drive to the computer to install the driver, and connects the computer to the peripheral device, whereupon finally the peripheral device can be used.

Furthermore, the problem exists that after the peripheral device is disconnected from the PC, the driver for that peripheral device remains stored on the hard disk of the PC. Once the peripheral device is disconnected from the PC, even though the driver for the peripheral device is no longer needed, it continues to occupy a part of the hard disk unless it is uninstalled by the user, reducing the available capacity of the hard disk. In some cases, such an unwanted driver even reduces the processing efficiency of the PC.

### SUMMARY

The present invention was devised in order to address the problems described above.

A first object of the present invention is to enable the use of a printer installed in a public place or similar location without the need to carry out a particular configuration operation or install a printer driver for the printer.

A second object of the present invention is to avoid the problems described above that arise when a peripheral device is used after it is connected locally to a computer, and to make the peripheral device easy to use via the computer.

A third object of the present invention is to improve user convenience when using a computer connected to a peripheral device.

The printing terminal of the present invention is a printing terminal connected to a printer, the terminal comprising: a connection port that is used to locally connect a printing data outputting device that outputs print data; an input unit that inputs from the printing data outputting device via the connection port first print data in which printing contents are stored using printer-independent generic draw format; a converter that converts the first print data into second print data that is interpreted by the printer; and an output unit that outputs the second print data to the printer.

According to the present invention, because the printing data outputting device is connected locally to the print terminal, printing can be easily performed without the need for a complex operation such as configuration of the TCP/IP settings or the workgroup, as might be required in the case of a network connection. Furthermore, when a network connection is used, there is a risk that the print data will leak, but because this risk is minimal when a local connection is used, a local connection is preferred as a more secure alternative in cases where a confidential document or the like is printed as well.

According to the present invention, the printing data outputting device that outputs print data can carry out printing regardless of the model of printer by outputting first print data in which print contents are recorded using printer-independent draw format. Therefore, printing can be performed in a simple manner without the need for prior installation of a printer driver or similar program targeted to the model of printer.

In the printing terminal having the above construction, the connection port is a swappable under a using condition. The type of connection port is called as hot-swappable.

Hot-swappable connection ports include a USB port or an IEEE 1394 port, for example. Conversely, connection ports that are not hot-swappable include a RS-232C port or a printer port (parallel port). When a connection port that is not hot-swappable is used, the printing data outputting device must be restarted when it is connected to the print terminal. However, if the connection port is made using a hot-swappable connection port as in the above construction, the printing data outputting device and the printing terminal can be connected without having to restart either device, and therefore user convenience can be increased.

The printing terminal having the above construction may include a notification unit that, where the printing data outputting device is connected to the connection port, notifies the printing data outputting device that the printing terminal is the output destination for the first print data.

Using this construction, even where multiple devices are connected to its connection port, the printing data outputting device can appropriately output the print data to the print terminal.

In the printing terminal having the above construction, the output unit may output the second print data over a network to the printer set in advance as an output destination.

Where the printing terminal and the printer are connected over a network, multiple printers may be connected to this network. However, by establishing the output destination printer in advance using this construction, printing can be easily performed without the need for a special user operation to select the output destination printer.

The printing terminal having the above construction may further include a characteristic data output unit that outputs characteristic data indicating prescribed characteristics of the printer to the print data output unit before the first data is input.

Such a printing terminal enables the printing data outputting device to generate first print data in response to the characteristics of the printer connected to the print terminal. The characteristic data may include, for example, information such as the paper sizes supported by the printer, the resolution, and the availability of a color printing function and a two-sided printing function.

In the printing terminal having the above construction, it is acceptable that the printing terminal is configured on a computer, and the converter comprises an application that reproduces the print contents based on draw format recorded in the first print data and a printer driver that generates the second print data based on the reproduced print contents in accordance with a print instruction issued from the application.

The above construction enables the present invention to be easily realized using a personal computer or the like.

In the printing terminal having the above construction, it is acceptable that the printing data outputting device is configured on a computer, and the printer driver is installed on the printing data outputting device if the printing data outputting device were connected directly to the printer.

Using this construction, the printing terminal may be easily established using an existing, widely available printer driver.

Furthermore, in order to achieve the objects described above, the printing data outputting device of the present invention is constructed in the manner described below. The device is a printing data outputting device that outputs print data to a printing terminal connected to a printer, such device including a characteristic data input unit that inputs from the printing terminal characteristic data indicating prescribed characteristics of the printer and a print data generator that generates in response to the characteristic data print data in which print contents are recorded using printer-independent generic draw format.

This type of printing data outputting device enables print data to be generated taking into consideration the characteristics of the printer connected to the print terminal. The characteristic data may be input when the printing data outputting device and the printing terminal are connected, when a print request is received from the user, or when the printer driver is installed on the printing data outputting device, for example. The characteristic data may be input in the form of a file in which the characteristic data is described, or as a part of the installation data for the printer driver. It is also acceptable if characteristic data for various models of printers is input in advance when the printer driver is installed, and the information specifying the printer model is output from the print terminal.

In the above invention, the various aspects described above may be applied by combining them or partially omitting them in an appropriate fashion. The present invention may also be realized in a form other than the construction described above that includes a printing terminal and a printing data outputting device, such as a print method by which a printing terminal connected to a printer executes printing, a method by which a printing data outputting device outputs print data, a computer program by which a printing terminal connected to a computer executes printing, a computer program by which a printing data outputting device outputs print data to a printing terminal connected to a printer, and a computer-readable recording medium on which such computer program is recorded, for example. In any form, the various aspects described above may be appropriately applied. Various types of media may be used for the computer-readable recording medium, such as, for example, a flexible disk, CD-ROM, DVD-ROM, opto-magnetic disk, IC card or hard disk.

The invention comprising a first peripheral device used in combination with the above printing terminal is a peripheral device that is connected locally to the connection port of a computer having a function of automatically executing a file stored in a prescribed area of a specific type of device when the device is connected to the computer, wherein the peripheral device is different from the specific type of device, the peripheral device comprises: a signal output unit that, when the peripheral device is connected to the connection port of the computer, outputs to the computer an identification signal that causes the peripheral device to be recognized as the specific type of device; and a storage function unit that stores the file to be executed by the computer, wherein the file comprises an installer for program used by the computer to output print data.

Using this construction, a prescribed file can be automatically executed on a computer when the peripheral device is connected to the computer. Therefore, by causing the peripheral device to be recognized as a CD-ROM drive even if no CD-ROM drive is present, the auto-run function can be executed on the computer. The ‘specific type of device’ may comprise, in addition to a CD-ROM drive device, a CD-R/RW drive device or a DVD-ROM/RAM/R/RW drive device.

In the first peripheral device of the present invention, the connection port may be a hot-swappable connection port.

Hot-swappable connection ports include, for example, a USB port or an IEEE 1394 port. When this type of hot-swappable connection port is used, the computer and peripheral device need not be rebooted when the connection between the two is made or terminated. Therefore, if the ‘connection port’ is a hot-swappable connection port, the computer and peripheral device can be connected without either having to be rebooted. Consequently, the ‘execution of a prescribed file’ can be carried out without rebooting the computer or the peripheral device.

In the first peripheral device of the present invention, it is acceptable if the stored file includes an installer for a program used by the computer to output print data, the signal output unit outputs an identification signal that, where the program is retrieved by the computer, causes the peripheral device to be recognized as a prescribed device to receive the print data, and the peripheral device further includes a mediation/relay function unit that mediates the print data output by the computer and relays it to a prescribed printing device connected to the peripheral device.

With this construction, the user can, simply by connecting a computer to the peripheral device of the present invention, install prescribed software such as a printer driver and carry out printing without changing the connection.

The peripheral device of the present invention may comprise a printing mediation/relay device (hereinafter a ‘print terminal’) that mediates the print data output by the computer and relays it to the printing device. Furthermore, it is acceptable if the peripheral device of the present invention forwards the print data obtained from the computer to the printing device after subjecting the print data to prescribed processing. For example, processing to convert the data format may be performed.

The peripheral device of the present invention may be connected to the ‘prescribed printing device’ locally or over a network. The peripheral device may alternatively be integrally formed with the ‘prescribed printing device’.

Where the peripheral device of the present invention mediates and relays the print data as described above, it is acceptable if, where a notification is received from the computer indicating that the software installation has been completed, the signal output unit outputs an identification signal that causes the peripheral device to be recognized as a prescribed device to receive the print data.

Using this construction, the identification signal can be output in response to the retrieval of the software by the computer.

A second peripheral device of the present invention is a peripheral device connected locally to the connection port of a computer, such peripheral device comprising: a plural of function supply units that, when the peripheral device is connected to the computer, enable the peripheral device to function as a specific type of device; a switching controller that provides a plural of functions to the computer by switching, according to a prescribed sequence, among identification signals that cause the computer to recognize that a specific type of device is connected, wherein one of the functions is install program used by the computer to output print data.

In this case, unlike the case in which multiple types of devices are connected to the computer, the functions of each function supply unit are recognized by the computer according to a prescribed sequence. As a result, the problems of complex processing by the computer and reduced user operability of the computer can be avoided. The above construction also enables the computer to execute the functions of each function supply unit via simple processes identical to those executed if multiple types of devices were connected to the computer. Therefore, special means to switch among the functions of the various function supply units (such as drivers, for example) need not be prepared or installed on the computer.

It is preferred that at least part of the function supply units of this invention provide functions that can be controlled by a generic driver such as a so-called class driver. For example, it is preferred that functions compatible with prescribed class specifications, such as USB mass storage class specifications, be provided. In this way, these functions can be easily executed on the computer.

In a second peripheral device of the present invention, it is acceptable if the switching controller controls the output signals sent to the connection port such that during the process of switching among the functions, the computer is caused to recognize that the connection was terminated once and subsequently re-established.

In this way, the peripheral device can change the type of device that is recognized by the computer.

In the second peripheral device of the present invention, it is acceptable if, when a prescribed type of device is connected to the connection port, the computer has a function to automatically execute a file stored in a prescribed area of the device, the peripheral device has a first function supply unit that stores a program that installs software used by the computer to output print data and sends this installer program to the computer as the file to be executed, as well as a second function supply unit that receives print data output by the computer and causes printing to be performed by a prescribed printing device in accordance with this print data, and the switching controller sends an identification signal that causes the peripheral device to be recognized as a prescribed device to receive the print data.

In the second peripheral device of the present invention, it is acceptable if the switching is carried out in response to a prescribed notification from the computer.

In addition to comprising the peripheral device described above, the present invention may be realized as a method invention comprising a peripheral device control method or a method in which a peripheral device connected to a computer supplies the computer with prescribed functions. It may also be realized in various other forms, including a computer program that realizes these methods, a recording medium on which this computer program is recorded, and data signals that include this program and are encoded in a carrier wave.

Where the present invention is realized as a computer program or a recording medium or the like on which this program is recorded, the recording medium may constitute one of various other computer-readable media, such as a flexible disk, CD-ROM, magnetic disk, IC card, ROM cartridge, punch card, printed matter on which symbols such as a bar code are printed, internal memory device for a computer (i.e., RAM, ROM or other memory) or external storage device.

An invention comprising a computer used in combination with the printing terminal described above will now be described. The program used in the computer of the present invention is a computer program that uninstalls software that was installed on the computer to enable the use of a peripheral device when the peripheral device has been locally connected to the computer, such computer program realizing on the computer the functions of (i) detecting that the local connection between the peripheral device and the computer has been terminated and (ii) executing a program to uninstall from the computer the installed software in response to this detection.

Using this construction, where the peripheral device is no longer being used, the computer can automatically uninstall the software that enables the use of the peripheral device. Such an uninstall operation can reduce the amount of data stored on the computer and increase the amount of recordable data. It can also increase the processing efficiency of the computer.

The ‘software to enable the use of the peripheral device’ may comprise a driver for the peripheral device. It may also comprise one of various types of application software that execute operation instructions on the peripheral device, such as image processing software that causes a printing device to execute printing.

The computer may furthermore be connected locally to the peripheral device via a hot-swappable connection port. Hot-swappable connection ports include, for example, USB ports or IEEE 1394 ports. A peripheral device that is connected to a hot-swappable connection port can be disconnected from the computer without shutting down the power to the computer or the peripheral device. Therefore, the user can perform an uninstall process on the computer in response to the termination of the local connection without having to shut down the power to the computer or the peripheral device.

Furthermore, the uninstall process is not limited to the case in which ‘software’ is to be completely deleted from the computer. For example, the case in which the data size of ‘software’ is to be compressed is also included.

In the computer program of the present invention, the program that executes the uninstall process may be realized as a function of the above-described software.

Using this construction, the computer program of the present invention can be easily installed on the computer when the ‘software to enable the use of the peripheral device’ is installed.

The computer program of the present invention need not be realized as a function of the ‘software to enable the use of the peripheral device’. For example, it may be realized as a function of the OS installed on the computer.

The computer program of the present invention may cause the function to switch between executing or not executing the uninstall program to be realized on the computer based on a prescribed condition.

Using this construction, the uninstall process can be avoided in certain cases. For example, the uninstall process can be avoided when a prescribed user instruction is issued. It may also be avoided where the amount of data stored on the computer is less than, equal to or greater than a prescribed amount, or where the size of the storage area that would be made available by executing the uninstall process is smaller than a prescribed value. Alternatively, the uninstall process can be avoided depending on the type of software to be uninstalled. For example, uninstallation of software that can be used for control of multiple types of peripheral devices, such as a class driver, may be avoided. In addition, the ‘prescribed condition’ that determines whether or not the uninstall process is to be executed may comprise a combination of the various conditions described above.

The present invention may be realized not only as the computer program described above, but also as one of various other forms, such as a recording medium on which the computer program is recorded or data signals that include this program and are encoded in a carrier wave. Where the present invention comprises a recording medium or the like on which this program is recorded, the recording medium may constitute one of various computer-readable media, such as a flexible disk, CD-ROM, magnetic disk, IC card, ROM cartridge, punch card, printed matter on which symbols such as a bar code are printed, internal memory device for a computer (i.e., RAM, ROM or other memory) or external storage device.

The uninstall method of the present invention is a method that was installed on a computer in order to enable the use of a peripheral device when the peripheral device is connected locally to the computer, the method comprising: detecting that the local connection between the peripheral device and the computer has been terminated; and uninstalling from the computer the installed program in response to this detection.

The computer of the present invention having a connection port that locally connects a peripheral device to the computer, the computer comprising: a storage unit that stores a program installed on the computer in order to enable the use of the peripheral device when the peripheral device is connected to the connection port; a detection unit that detects that the peripheral device has been disconnected from the connection port; and
an uninstall unit that uninstalls the program stored in the storage unit in response to this detection.

As described above, in addition to comprising a computer program, the present invention may be realized as a method invention comprising a method to execute an uninstall process on a computer or a computer control method, or as a computer on which an uninstall process is executed.

### BRIEF DESCRIPTION OF THE DRAWINGS

FIG. 1 is an explanatory drawing showing the basic construction of a printing system comprising an embodiment.

FIG. 2 is a flow chart of the execution of a process to automatically install a generic printer driver in the first embodiment.

FIG. 3 is a flow chart of a printing process executed on the user PC 200.

FIG. 4 is a flow chart of a printing process executed on the printing terminal 300.

FIG. 5 is an explanatory drawing showing the basic construction of a printing system 500 comprising a modification.

FIG. 6 is an explanatory drawing showing the basic construction of a printing system 100A comprising a second embodiment.

FIG. 7 is a flow chart of a printing process executed in the printing system 100A of the second embodiment.

FIG. 8 is an explanatory drawing showing the basic construction of a printing system 100B comprising a third embodiment.

### DESCRIPTION OF THE PREFERRED EMBODIMENTS

Embodiments of the present invention will be explained below in the following sequence.

A. Basic construction of printing system of first embodiment
(A-1) Basic construction of user PC
(A-2) Basic construction of print terminal

B. Automatic installation of generic printer driver

C. Printing process on user PC

D. Printing process on print terminal

E. Modifications
(E-1) Modification 1
(E-2) Other modifications

F. Basic construction of printing system of second embodiment
(F-1) Overall construction
(F-2) Basic construction of user PC
(F-3) Basic construction of print terminal

G. Printing process of second embodiment
(G-1) Automatic installation of generic printer driver
(G-2) Printing process
(G-3) Automatic uninstall

H. Operation and effect of second embodiment

I. Basic construction of printing system of third embodiment

J. Operation and effect of third embodiment

### A. Basic Construction of Printing System

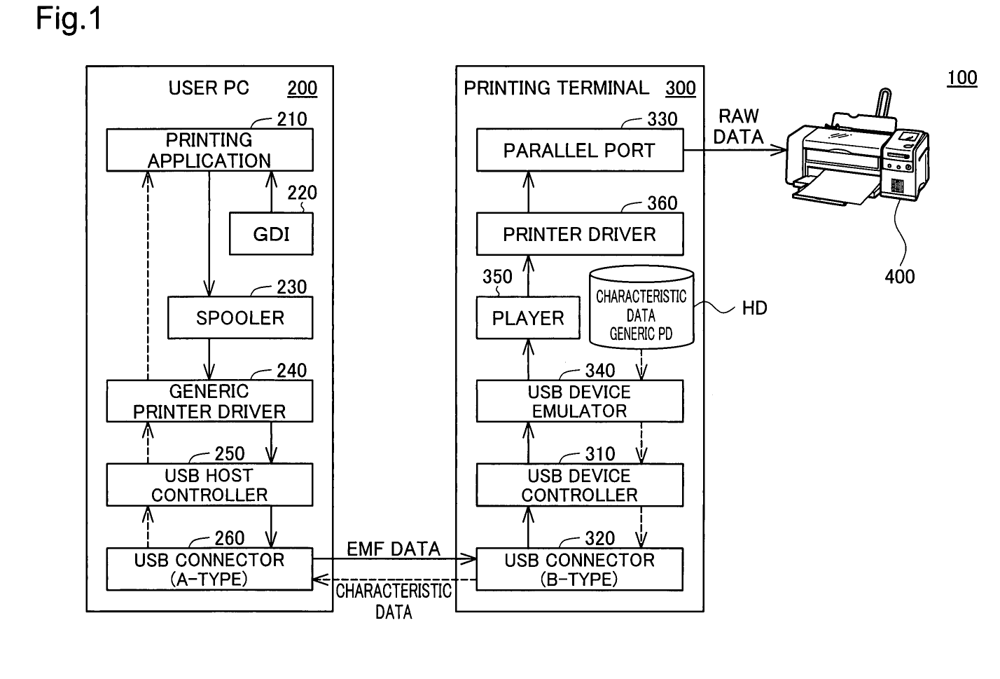

FIG. 1 is an explanatory drawing showing the basic construction of the printing system 100 of this embodiment. The printing system 100 comprises a user PC 200, a printing terminal 300 and a printer 400. The user PC 200 is a so-called notebook personal computer, and has the Windows® OS installed thereon. The printing terminal 300 is also a personal computer and has the Windows® OS installed thereon.

The printing terminal 300 and the printer 400 are connected by a printer cable, and are installed in an airport lobby, library or other public place. The user can easily perform printing by locally connecting the user PC via a USB cable to the printing terminal 300 installed in such a location.

(A-1) Basic Construction of User PC

The user PC 200 includes as software a printing application 210, a GDI 220, a spooler 230 and a generic printer driver 240, and includes as hardware a USB host controller 250 and a USB connector (A-type) 260.

The printing application 210 is software that includes a printing function, such as document creation software, spreadsheet software or image processing software. When the user issues a print instruction, the printing application 210 calls draw format of the GDI (Graphic Device Interface) 220, which is one of the modules comprising a kernel of the OS, and generates EMF (Enhanced Meta File) data. EMF data is an intermediate file used in order to speed up printing in a Windows environment and has a series of GDI command. In other words, EMF data includes printing contents recorded using draw command and stored in GDI format that do not depend on the printer 400. When the EMF data is generated in this fashion, the printing application 210 sends it to the spooler 230. The spooler 230 is a module that is included as a standard feature in the OS to enable buffering of the EMF data generated by the printing application 210 or the like.

The generic printer driver 240 includes a function to sequentially retrieve the EMF data that accumulates in the spooler 230 and send it to the printing terminal 300 via the USB host controller 250. The generic printer driver 240 also has a function to obtain from the printing terminal 300, if necessary, characteristic data indicating prescribed characteristics of the printer 400. The printing application 210 can generate EMF data according to a desired print format by carrying out printing configuration using this characteristic data. The characteristic data contains definitions regarding, for example, the paper sizes supported by the printer, the resolution, and the availability of a color printing function and a two-sided printing function. The printing application 210 has a function to configure the options for generation of the EMF data using this characteristic data. As a result, EMF data corresponding to the characteristics of the printer 400A can be generated. It is also acceptable if the generic printer driver 240 stores various sets of characteristic data in advance and data specifying one of these data sets is obtained from the printing terminal 300A.

The generic printer driver 240 is automatically installed when the user PC 200 is connected to the printing terminal 300. This automatic installation process will be described in more detail below.

The USB host controller 250 is a controller that controls various USB devices, such as a USB mouse, USB keyboard and USB printer. The USB connector (A-type) 260 is a connector that electrically connects such a USB device using a USB cable. In this embodiment, the USB controller 250 controls the printing terminal 300 comprising a USB device.

(A-2) Basic Construction of Print Terminal

The printing terminal 300 includes as hardware a USB device controller 310, a USB connector (B-type) 320, a parallel port 330 and a hard disk HD, and includes as software a USB device emulator 340, a player 350 and a printer driver 360.

The USB device controller 310 is a controller that receives USB device control from the USB host controller of the PC 200. The USB device controller 310 and the USB connector (B-type) 320 are installed on an expansion board and are connected to a PCI bus via the PCI slot of the printing terminal 300.

The USB device emulator 340 is a device driver that controls the USB device controller 310, and has a function to cause the user PC 200 to recognize the printing terminal 300 not as a personal computer but as a USB device such as a USB printer device or USB mass storage device. Causing the printing terminal 300 to be recognized as a USB mass storage device enables the generic printer driver 240 to carry out the automatic installation function described below to be realized.

The USB device emulator 340 has a function to receive EMF data sent from the user PC 200 and forward this EMF data to the player 350. It also has a function to send the characteristic data for the printer 400 stored on the hard disk HD of the printing terminal 300 or the installation data for the generic printer driver 240 in response to a request from the user PC 200.

The player 350 is an application that prints the EMF data forwarded from the USB device emulator 340. When the printing process is executed by the player 350, the player 350 obtains the device context of the printer 400 from the printer driver 360 and generates printing contents via the GDI command recorded in the EMF data. When this occurs, the printer driver 360 generates RAW data that can be interpreted by the printer in accordance with the printing contents. In other words, in this embodiment, the EMF data forwarded from the PC 200 is converted through the operation of the player 350 and the printer driver 360 into RAW data that is interpretable by the printer 400.

The printer driver 360 prints the generated RAW data by sending it to the printer 400 via the parallel port 330. A printer driver that should be installed on the user PC 200 if the user PC 200 were directly connected to the printer 400 may be used as the printer driver installed on the printing terminal 300. In other words, a generally used printer driver, and not a special printer driver, may be used.

In this embodiment, the printing terminal 300 and the printer 400 are connected via the parallel port 330, but they may be connected over an RS-232C port or USB port or over a network. Furthermore, while the USB device emulator 340 and the player 350 comprised separate modules in this embodiment, they may be formed as an integral unit by incorporating the functions of the player 350 in the USB emulator 340.

### B. Automatic Installation of Generic Printer Driver

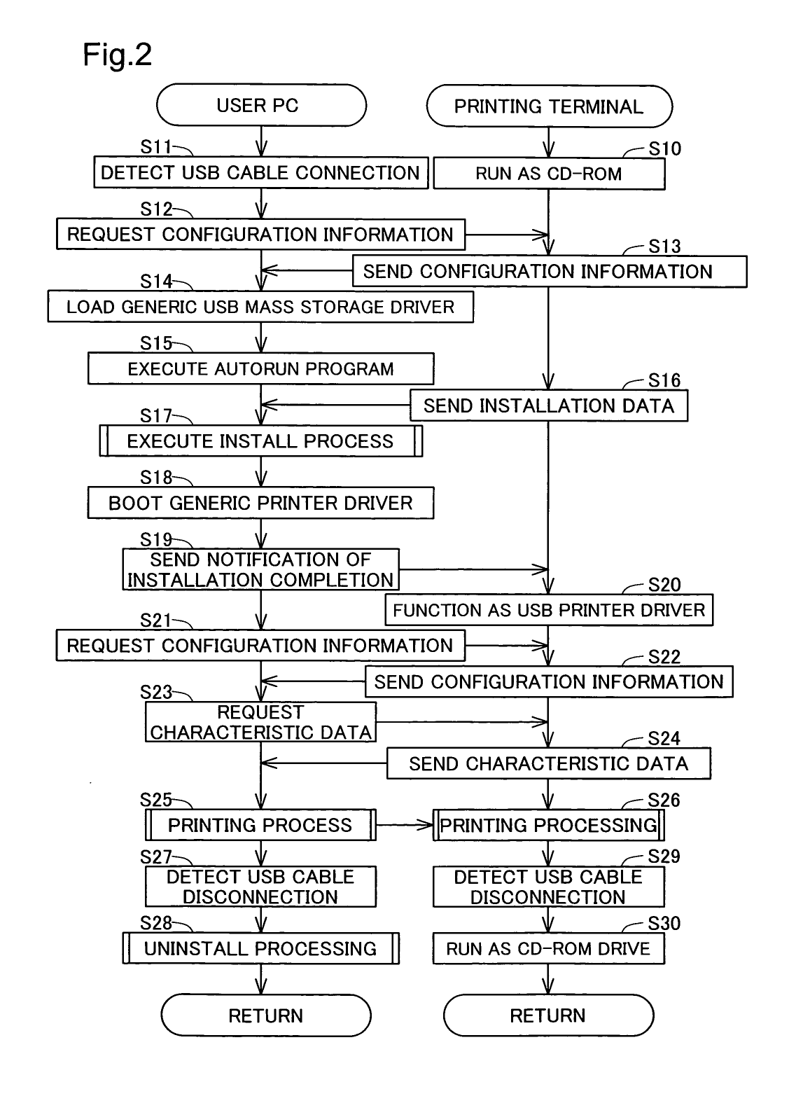

FIG. 2 is a flow chart of the automatic installation of the generic printer driver 240 on the user PC 200.

First, the printing terminal 300 operates as a USB mass storage device in the initial state via the operation of the USB device emulator 340 (step S10). Specifically, emulation is carried out so that the printing terminal 300 operates as a CD-ROM drive. In addition to a CD-ROM drive, the printing terminal 300 may operate via emulation as a CD-R/RW drive or as a DVD-ROM/RAM/R/RW drive.

Next, when the user PC 200 detects that it has been connected to the printing terminal 300 via a USB cable (step S11), the user PC 200 asks the printing terminal 300 to send configuration information (step S12). When this occurs, the printing terminal 300 sends configuration information to the user PC in response to this request (step S13). The configuration information includes such information as the printing terminal 300's unique device ID and the manufacturer's vendor ID, as well as information indicating that the printing terminal 300 is operating as a CD-ROM drive in compliance with USB standards.

When this configuration information is obtained, the user PC 200 recognizes the printing terminal 300 as a CD-ROM drive and loads a generic USB storage driver included in the OS as a standard feature (step S14). As a result, the user PC 200 can treat the printing terminal 300 as a CD-ROM drive.

Next, the user PC 200 executes the autorun program stored on the printing terminal 300 that it recognizes as a CD-ROM drive (step S15). When this autorun program is executed, installation data for the generic printer driver 240 is sent from the printing terminal 300 to the user PC (step S16). Where a file named ‘autorun.inf’ is stored in the CD-ROM root folder, the Windows OS executes any program specified by this file. In this embodiment, using this function, the installation of the generic printer driver 240 stored on the hard disk HD of the printing terminal 300 is executed.

Once the generic printer driver 240 installation process is executed (step S17), the user PC 200 boots the installed generic printer driver 240 (step S18). When this occurs, the generic printer driver 240 sends a notification to the printing terminal 300 indicating that installation has been completed (step S19). This notification may be made by sending a specific command or by writing a prescribed file to the CD-ROM drive. When this notification is received, the printing terminal 300 resets the USB device controller 310 via the USB device emulator 340, and switches its function from the function to operate as a CD-ROM drive to the printing terminal 300's original function as the original USB printer device (step S20).

When the USB device controller 310 is reset in this fashion, the user PC 200 recognizes that the CD-ROM drive has been disconnected and that a new USB device has been connected. When this occurs, the user PC 200 asks the printing terminal 300 for configuration information as in step S12 above (step S21) and in response to such request, the printing terminal 300 sends as configuration information the device ID, the vendor ID, and the fact that the printing terminal 300 itself is now a USB printer device (step S22). The user PC 200 can recognize the printing terminal 300 as a USB printer after receiving this configuration information.

The user PC 200, prior to printing, issues a request to the printing terminal 300 for characteristic data indicating the characteristics of the printer 400 (step S23). The USB device emulator 340 of the printing terminal 300 then sends characteristic data to the user PC 200 in response to this request (step S24). The user PC 200 can perform printing in accordance with the characteristics of the printer 400 using this characteristic data. While the characteristic data is sent to the user PC 200 on its own in this embodiment, it may also be sent to the user PC 200 as a configuration file for the generic printer driver 240 when the installation data for the generic printer driver 240 is sent in step S16. It is also acceptable if characteristic data for various printer models is installed in advance during installation of the generic printer driver 240 and the model information for the printer 400 is sent from the printing terminal 300 in this step S24. This process as well enables the user PC 200 to recognize the characteristics of the printer 400.

When the series of operations of the automatic installation process is completed, the user PC 200 and the printing terminal 300 can execute the printing processes (steps S25, S26). The respective printing processes are described in detail below. Once the printing processes are completed, the user disconnects the user PC 200 and the printing terminal 300. When the user PC 200 detects that the USB cable is disconnected (step S27), the user PC 200 executes the uninstall process for the generic printer driver 240 (step S28). At the same time, when the disconnection of the USB cable is detected by the printing terminal 300 (step S29), emulation is carried out once more such that the printing terminal 300 operates as a CD-ROM drive (step S30).

According to the automatic installation process described above, the user can easily perform printing using the printing terminal 300 even if the generic printer driver 240 is not installed on the user PC 200 in advance.

### C. Printing Process on User PC 200

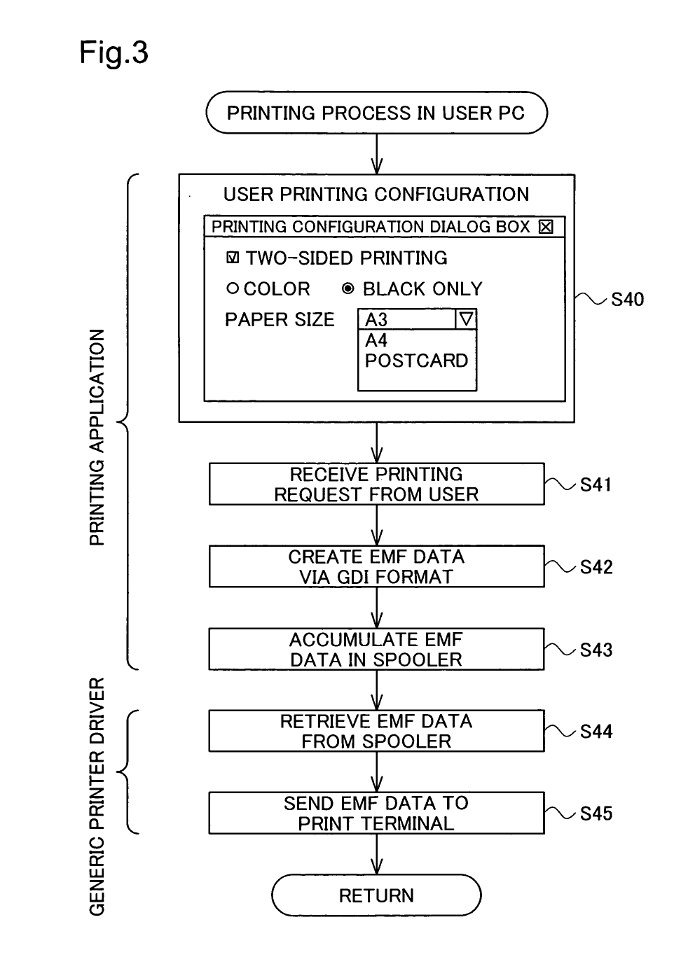

FIG. 3 is a flow chart of the printing process executed on the user PC 200. The process is equivalent to the operations performed in step S25 in FIG. 2.

First, the user of the user PC 200 carries out any necessary printing configuration prior to printing using the print application 210 (step S40). In the drawing, an example of a configuration dialog box displayed on the monitor during this printing configuration is shown. This configuration dialog box is displayed via the operation of the generic printer driver 240 based on the characteristic data obtained from the printing terminal 300. In this embodiment, configuration regarding whether or not to print on both sides, color/monochrome designation and paper size selection can be carried out.

Next, when a print request is received from the user via the pressing of the Print button, for example (step S41), the print application 210 generates EMF data corresponding to the printing contents using GDI format (step S42). The generated EMF data is then stored in the spooler 240 (step S43).

When the EMF data is retrieved from the spooler 230 (step S44), the generic printer driver 240 sends this EMF data to the printing terminal 300 (step S45). The printing process on the user PC 200 is completed upon the completion of these operations.

### D. Printing Process on Printing Terminal 300

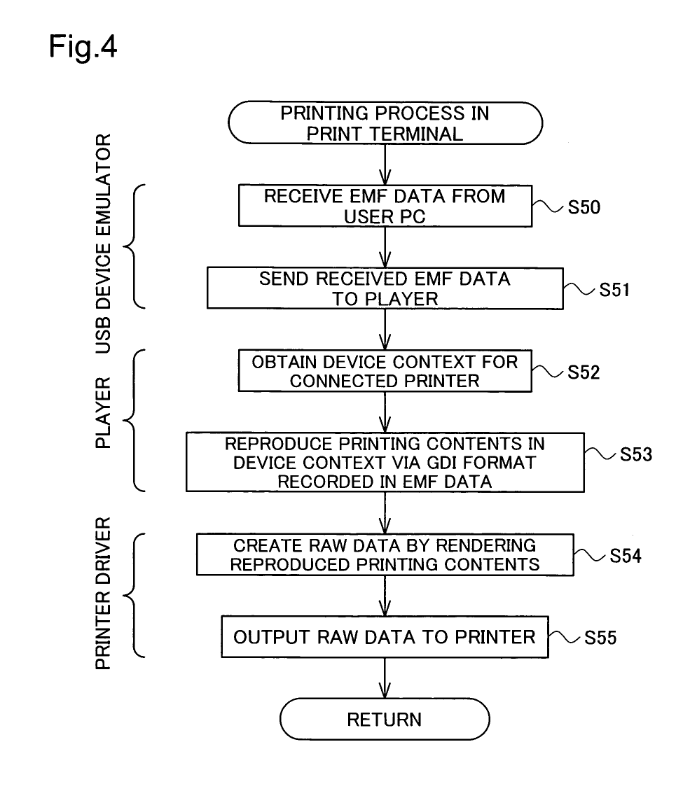

FIG. 4 is a flow chart of the printing process executed on the printing terminal 300. This process is equivalent to the operations performed in step S26 in FIG. 2.

First, after the USB device emulator 340 of the printing terminal 300 receives the EMF data from the user PC 200 (step S50), it sends the EMF data to the player 350 (step S51).

When the EMF data is input from the USB device emulator 340, the player 350 obtains the device context of the printer 400 from the printer driver 360 (step S52) and reproduces the printing contents via the GDI format stored in the EMF data (step S53).

Once the printing contents are reproduced by the player 350, the printer driver 360 renders the reproduced printing contents and generates RAW data that can be interpreted by the printer 400 (step S54). This RAW data is then output to the printer 400 (step S55). With these operations, the printing process on the printing terminal 300 ends.

According to this embodiment, because the user PC 200 and the printing terminal 300 are connected via a USB cable, the user PC 200 need not be rebooted. This provides a higher level of convenience than a connection via a parallel port or an RS-232C port, which basically require rebooting. Furthermore, where the user PC 200 and the printing terminal 300 are connected over a network, for example, complex configuration operations such as TCP/IP configuration and workgroup configuration must be carried out, but printing is much easier when a local USB connection is used because such configuration operations are not necessary. Furthermore, when a network connection is used, there is a risk that the print data will leak or be output from a printer installed at a location different from that intended by the user, but because these risks are minimal when a local connection is used, security can be maintained when printing confidential documents or the like.

In this embodiment, because the generic printer driver 240 is automatically installed on the user PC 200, the user can easily use a printer 400 installed at a public location such as a meeting room, airport lobby or library. Moreover, because the automatically installed generic printer driver 240 is automatically uninstalled when the printer 400 is no longer in use, there is no modification of the user PC operating environment and no consumption of hard disk capacity.

In addition, because the generic printer driver 240 sends to the printing terminal 300 the EMF data generated by the printing application 210 in its existing format, the load on the CPU can be minimized when the user PC 200 has low processing capability.

### E. Modifications

While an embodiment of the present invention was described above, the present invention is not limited to such embodiment, and various different constructions may be adopted within the essential scope thereof. For example, the following modifications are possible.

(E-1) Modification 1

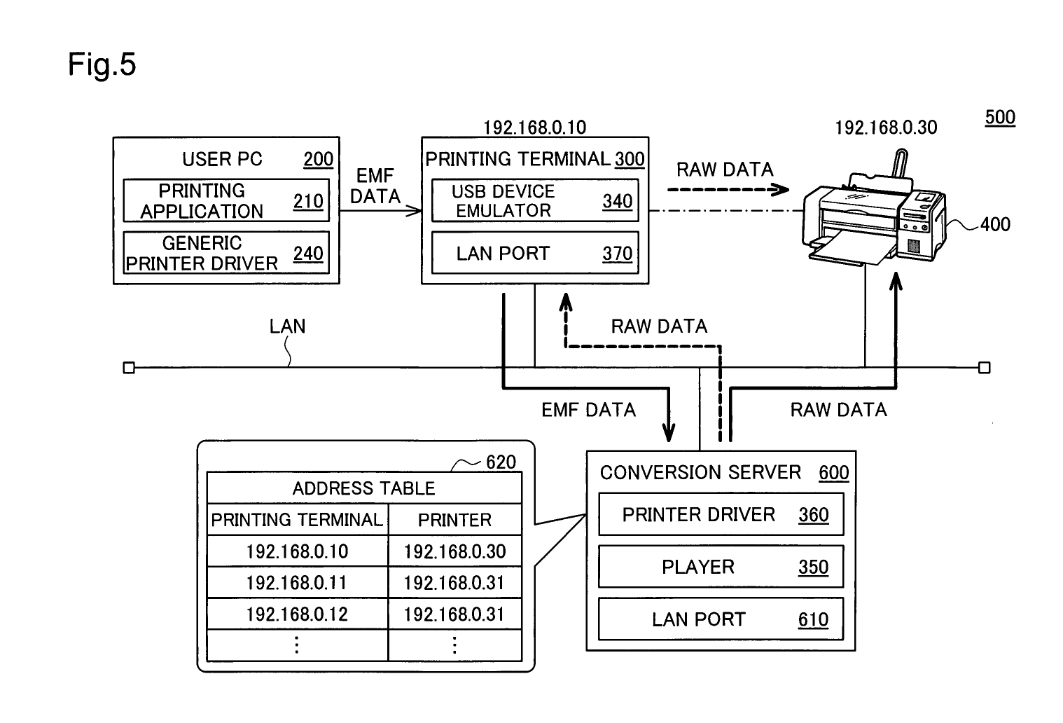

FIG. 5 is an explanatory drawing showing the basic construction of a printing system 500 comprising a modification. In the above embodiment, the printing terminal 300 and the printer 400 were connected via a printer cable. However, in this modification, they are connected over a network, and there is in addition a conversion server 600 to which some of the functions of the printing terminal 300 are diverted. The block diagram of FIG. 5 shows the various components in a simplified fashion.

The printing terminal 300 of this modification includes a USB device emulator 340 and a LAN port 370. When the EMF data is received from the user PC 200 via the USB device emulator 340, the printing terminal 300 forwards the received EMF data to the conversion server 600 via the LAN port 370.

The conversion server 600 includes a LAN port 610, a player 350 and a printer driver 360. When the EMF data is received from the printing terminal 300 via the LAN port 610, the conversion server 600 converts the EMF data into RAW data through the operation of the player 350 and the printer driver 360. The converted RAW data is sent to the printer 400 over the network.

The conversion server 600 includes an address table 620 used to associate the IP addresses of print terminals 300 with the IP addresses of printers 400. In the drawing, an address table that uses IP addresses is shown, but MAC addresses or other addresses may be used as well. In this address table 620, the printing terminal 300 and printer 400 installed at the user's location are associated. This avoids the situation where the printing contents are output by a printer installed at a location that the user did not intend. By referring to this address table 620, the printing terminal 300 can execute printing by a specific printer 400 set in advance even where multiple print terminals 300 and printers 400 are connected over a network. As a result, the user can easily perform printing without the need to specify the output destination printer.

In this modification, the printer 400 may be connected locally to the printing terminal 300 via a printer cable or the like, as shown by the chain dot line in the drawing. In this construction, the conversion server 600 returns the generated RAW data to the printing terminal 300 (see the dashed line in the drawing). The printing terminal 300 outputs this returned RAW data to the printer 400 via the printer cable.

According to the modification described above, by diverting some of the functions ordinarily possessed by the printing terminal 300 to a conversion server 600 connected over a network, the processing burden imposed on each device can be reduced.

(E-2) Other Modifications

In the above embodiment, the generic printer driver 240 was automatically installed. However, it is acceptable if the generic printer driver 240 is incorporated in the OS as a standard feature. If such a construction is used, the printing terminal 300 can be used immediately without the need for the automatic installation process described above.

If there is sufficient hard disk capacity on the user PC 200, the generic printer driver 240 that was installed previously need not be uninstalled. In this case, printing can be executed without having to reinstall the generic printer driver 240. Such a capability can be realized by, for example, during the uninstall process of step S28 in FIG. 2, detecting the remaining hard disk capacity on the user PC 200 and determining whether or not to execute the uninstall process based on this remaining hard disk capacity. Such remaining disk capacity criteria may be set to be approximately 1 GB, for example.

### F. Basic Construction of Printing System of Second Embodiment

(F-1) Overall Construction

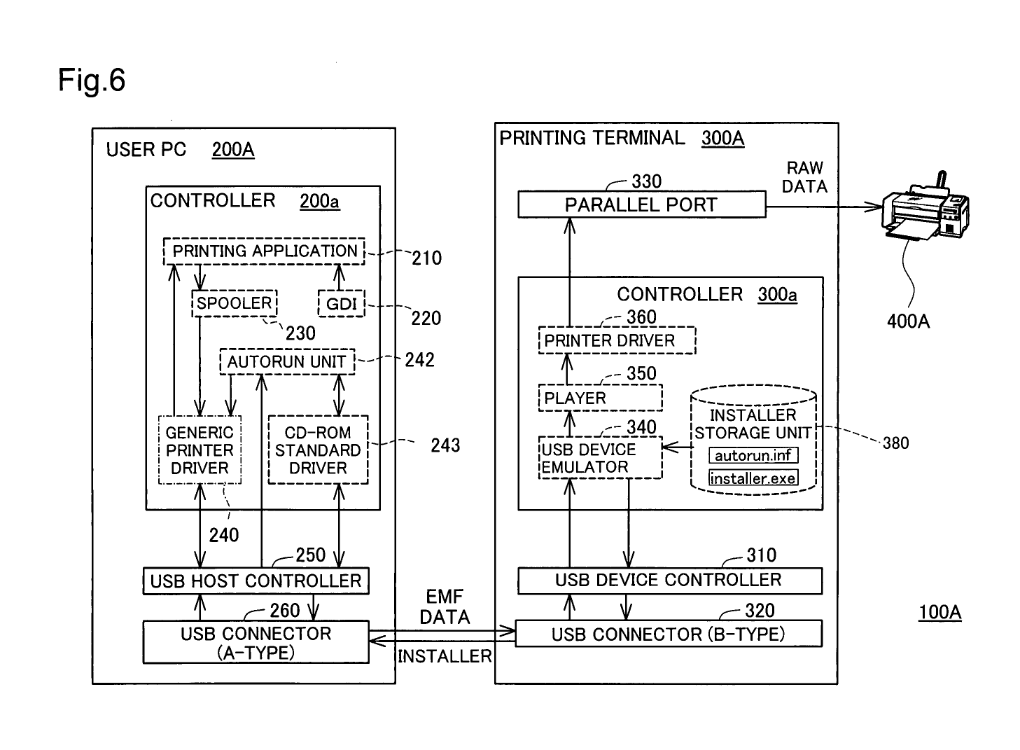

FIG. 6 is an explanatory drawing showing the basic construction of a printing system 100A of this embodiment. The printing system 100A comprises a user PC 200A, a printing terminal 300A and a printer 400A. The user PC 200A is a so-called notebook personal computer, and has the Windows® OS installed thereon. The printing terminal 300A is also a personal computer and has the Windows® OS installed thereon.

The printing terminal 300A is connected to the printer 400A via a printer cable. The printing terminal 300A is installed in a public place such as an airport lobby or a library. The user can easily perform printing by locally connecting the user PC 200A to the printing terminal 300A installed in such a location using a USB cable. The user PC 200A serves as a USB host and controls the operations of the printing terminal 300A that serves as a USB device.

The printing terminal 300A includes as hardware a USB connector (B-type) 320, a USB device controller 310, a controller 300a and a parallel port 330. The user PC 200A includes as hardware a USB connector (A-type) 260, a USB host controller 250 and a controller 200a. Of these components, those having the same functions as in the first embodiment are assigned the same symbols and are not described in detail below.

The controllers 200a and 300a of the user PC 200A and printing terminal 300A, respectively, each comprise a CPU, a ROM, a RAM and the like, and each control the other hardware components of the user PC 200A and the printing terminal 300A. FIG. 6 shows function blocks that are realized by the controllers 200A and 300A via software (shown by dashed lines and chain dot lines in the drawing). However, all or part of the function blocks shown in the drawing may be realized via hardware.

The printing terminal 300A includes as function blocks a USB device emulator 340, a player 350, a printer driver 360 and an installer storage unit 380, as in the first embodiment. The user PC 200A includes a printing application 210, a GDI 220, a spooler 240, a CD-ROM standard driver 243, an autorun unit 242 and a generic printer driver 240. The generic printer driver 240 is installed by the autorun unit 242 on the user PC 200A, as described below.

(F-2) Basic Construction of User PC 200A

In the user PC 200A, the CD-ROM standard driver 243 and the generic printer driver 240 are each device drivers that enables the use of USB devices connected to the USB connector 260. The CD-ROM standard driver 243 is a class driver that can be commonly used for standard CD-ROM devices designed to be compatible with the USB mass storage class specifications. The CD-ROM driver 243 is pre-installed in the user PC 200A at the time of factory shipment. At the same time, the generic printer driver 240 is a printer driver that can be used generically for prescribed printing apparatuses. The generic printer driver 240 was described in connection with the first embodiment.

When a USB device is connected to the USB connector 260, the OS of the user PC 200A asks the USB device to send configuration information in order to identify the type of the USB device. Where a peripheral device that can be controlled by the CD-ROM standard driver 243 is connected to the USB connector 260, the OS of the user PC 200A boots the CD-ROM standard driver 243, while if a peripheral device that can be controlled by the generic printer driver 240 is connected to the USB connector 260, it boots the generic printer driver 240.

The autorun unit 242 is one of the function blocks implemented by the Windows OS installed on the user PC 200A and implements an autorun function. Specifically, where a CD-ROM drive device is connected to the USB port 260, the autorun unit 242 retrieves the autorun file having the file name ‘autorun.inf’ and stored in the root folder of the CD-ROM drive device, and executes the program specified by this file. The autorun unit 242 of this embodiment installs the generic printer driver 240 based on this autorun function.

Because the printing application 210, generic printer driver 240 and other blocks belonging to the user PC 200A have the same functions as the corresponding blocks in the first embodiment, they will not be described here.

(F-3) Basic Construction of Print Terminal

The USB device emulator within the printing terminal 300A sends configuration information to the user PC 200A using the USB device controller 310. The USB device emulator 340 distinguishes between the configuration information that causes the user PC 200A to recognize the printing terminal 300A as a CD-ROM drive device and the configuration information that causes the user PC 200A to recognize the printing terminal 300A as a printing device. In the former case, the configuration information causes the user PC 200A to boot the CD-ROM standard driver 243, while in the latter case, the configuration information causes the user PC 200A to boot the generic printer driver 240. In the discussion below, the two configuration information sets are abbreviated as first and second configuration information.

The installer storage unit 380 stores an autorun file that is retrieved by the user PC 200A when the user PC 200A recognizes the printing terminal 300A as a CD-ROM drive device. This autorun file specifies a prescribed installer that is also stored in the installer storage unit 380 as the file to be automatically executed by the user PC 200A. The autorun unit 242 of the user PC 200A can install the generic printer driver 240 on the user PC 200A using this installer.

The USB device emulator 340 includes a self-reset function. When a reset is performed, the user PC 200A treats the connection between the USB connector 260 and the printing terminal 300A as terminated once and then re-established. In such a case, the user PC 200A obtains configuration information from the printing terminal 300A once more.

Furthermore, the USB device emulator 340 includes a function to obtain EMF data from the user PC 200A that recognizes the printing terminal 300A as a printing device. The USB device emulator 340 forwards the obtained EMF data to the player 350.

The constructions and operations of other blocks of the printing terminal 300A, such as the player 350 and printer driver 360, for example, are identical to those of the corresponding blocks in the first embodiment, and will not be described further here.

### G. Printing Process of Second Embodiment

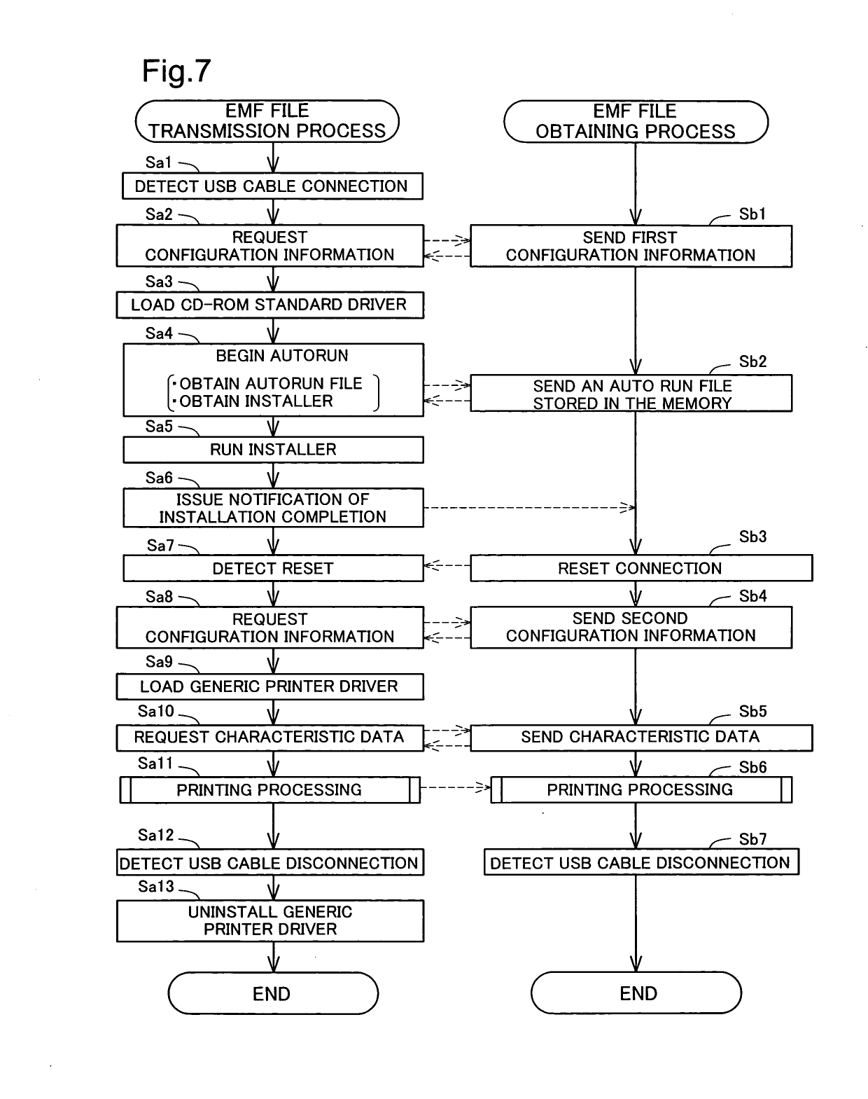

The printing process of the second embodiment will now be described. FIG. 7 is a flow chart of the process performed in order to execute printing via the printing system 10A.

(G-1) Automatic Installation of Generic Printer Driver

In step Sa1, the user PC 200A detects that it is connected to the printing terminal 300A via a USB cable. The user PC 200A begins the process shown in the flow chart at the left side of FIG. 7 in response to the connection to the printing terminal 300A. In step Sa2, the user PC 200A asks the printing terminal 300A to send configuration information. The printing terminal 300A begins the process shown in the flow chart shown at the right side of FIG. 7 in response to this request.

In step Sb1, the printing terminal 300A sends the first configuration information to the user PC 200A. As a result, the user PC 200A recognizes that a CD-ROM drive device has been connected to the USB connector 260. Consequently, the user PC 200A loads the CD-ROM standard driver 243 into memory (step Sa3).

Because the user PC 200A recognizes that a CD-ROM drive device has been connected, the user PC 200A thereafter performs the autorun process. First, the user PC 200A obtains the autorun file from the printing terminal 300A, and then it retrieves the installer specified by the obtained autorun file (step Sa4). The user PC 200A then installs the generic printer driver 240 on itself by executing the retrieved installer (step Sa5). In response to the completion of installation, the installer executed by the user PC 200A sends a completion notification to the printing terminal 300A indicating that installation has been completed (step Sa6). The user PC 200A issues a completion notification via the transmission of a signal incorporating a CD-ROM media eject instruction. Alternatively, the user PC 200A may issue the completion notification via the transmission of an instruction to write a prescribed file to the drive. It is also acceptable if the user PC 200A does not issue a completion notification. In this case, the printing terminal 300A may perform the reset process of step Sb3 immediately after the installer has been sent (step Sb2).

When the completion notification is received, the printing terminal 300A resets the USB device emulator 340 (step Sb3). Where the user PC 200A detects the reset by the printing terminal 300A (step Sa7), the printing terminal 300A is asked to send configuration information, as in step Sa2 above (step Sa8). In response to this request, the printing terminal 300A sends the second configuration information (step Sb4). Upon receiving this configuration information, the user PC 200A recognizes the printing terminal 300A as a printing device and loads the generic printer driver 240 into memory (step Sa9).

In step Sa10, the generic printer driver 240 loaded into memory asks the printing terminal 300A to send characteristic data (step Sa10). The printing terminal 300A sends the characteristic data in response to the request from the user PC 200A (step Sb5). It is also acceptable if the characteristic data is obtained from the printing terminal 300A by the installer in step Sa5.

When this series of operations of the automatic installation process is completed, the user PC 200A and printing terminal 300A can execute the printing processes (steps Sa1, Sb6).

In this embodiment, the USB device emulator 340 causes the user PC 200A to recognize the printing terminal 300A as a CD-ROM drive device. However, instead of causing the printing terminal 300A to be recognized as a CD-ROM drive device, it may cause the printing terminal 300A to be recognized as a CD-R/RW drive or DVD-ROM/RAM/R/RW drive. The user PC 200A may additionally be caused to recognize the printing terminal 300A as any other type of peripheral device, so long as the autorun process can be executed on the PC for such device.

The installer checks in step Sa6 in FIG. 7 whether or not the generic printer driver 240 is already installed on the user PC 200A, and installs it only if it is not already installed.

(G-2) Printing Process

The printing process executed on the user PC 200A where printing is in fact performed (the operations equivalent to step Sa11 in FIG. 2) is identical to that carried out in the first embodiment (see FIG. 3). Furthermore, the process carried out by the printing terminal 300A corresponding to the process carried out by the user PC 200A is also identical to that carried out in the first embodiment (see FIG. 4). Therefore, these processes will not be described in detail here.

In any case, by virtue of the printing processes carried out by the user PC 200A and the printing terminal 300A, respectively, the printing contents are reproduced by the player 350 of the printing terminal 300A, and the printer driver 360 that receives the reproduced printing contents renders these contents and generates RAW data that can be interpreted by the printer 400 (see step S54 in FIG. 4). Because this RAW data is output to the printer 400A (step S65 in FIG. 4), printing is effectively carried out by the printer 400A based on the data output by the user PC 200A, enabling the desired printing results to be obtained.

Where the print processes described above are executed, because the generic printer driver 240 sends the EMF data generated by the printing application 210 to the printing terminal 300A in its existing format, the load on the CPU can be minimized when the user PC 200A has low processing capability.

(G-3) Automatic Uninstall

Once printing processes are completed (steps Sa11, Sb6 in FIG. 7), the user terminates the connection between the user PC 200A and the printing terminal 300A. When the user PC 200A detects that the USB cable has been disconnected (step Sa12), it ends processing after the generic printer driver 240 is uninstalled (step Sa13). On the other hand, the printing terminal 300A ends processing in response to the disconnection of the USB cable (step Sb7).

The automatic uninstall process described above enables the generic printer driver 240 to be automatically uninstalled once the printer 400A is no longer being used. As a result, an increase in the amount of data stored on the hard disk of the user PC 200A can be prevented. Furthermore, the registration of the generic printer driver 240 that has been rendered superfluous can be prevented from remaining in the OS of the user PC 200A.

The automatic uninstall process (step Sa13 in FIG. 7) may be omitted. It is also acceptable if the user PC 200A executes the uninstall process in step Sa13 of FIG. 7 if a prescribed condition is met. For example, it is acceptable if the user PC 200A detects the amount of remaining hard disk capacity and does not execute the uninstall process if the remaining capacity exceeds a prescribed amount. This prescribed amount of hard disk capacity may be set at approximately 1 GB, for example. The uninstall execution condition may be based on the amount of hard disk capacity that would be freed up by the uninstall process, or may involve a prescribed user instruction.

In step Sa13 in FIG. 7, the data comprising the generic printer driver 240 need not be completely deleted from the user PC 200A. For example, the registration of the generic printer driver 240 may be merely temporarily deleted from the OS. Alternatively, the data comprising the generic printer driver 240 may simply be compressed.

### H. Operation and Effect of Second Embodiment

According to the above embodiment, the user can install the generic printer driver 240 on the user PC 200A and perform printing using the generic printer driver 240 simply by connecting the user PC 200A to the printing terminal 300A. Therefore, if the above-described printing terminal 300A is used, a printing mediation/relay function can be provided to any given user PC 200A regardless of whether or not a generic printer driver 240 is installed on the user PC 200A.

Furthermore, the printing terminal 300A described above can cause the autorun function to be executed on the user PC 200A regardless of what functions are present on the printing terminal 300A. As a result, the party supplying the printing terminal 300A can carry out automatic installation of the generic printer driver 240 onto the user PC 200A simply by providing the printing terminal 300A.

Where the printing terminal 300A described above is connected to the user PC 200A, the number of peripheral devices recognized by the user PC 200A does not increase by more than one, unlike the case where a CD-ROM drive device and a printing device are connected. Furthermore, the user PC 200A controls the above printing terminal 300A using two drivers (the generic printer driver 240 and the CD-ROM standard driver 243). Because driver switching may be performed based on the configuration information, the user PC 200A can switch easily between the functions possessed by the printing terminal 300A without the need for special software.

Because the user PC 200A and printing terminal 300A are connected via USB, the complex configuration operations required for a network connection, such as TCP/IP configuration and workgroup configuration, are not required. Furthermore, when a network connection is used, there is a risk that the print data will leak or be output from a printer installed at a location different from that intended by the user, but because this risk is minimal when a local connection is used, a local connection is preferred as a more secure alternative in cases where a confidential document or the like is printed as well.

### I. Basic Construction of Third Embodiment

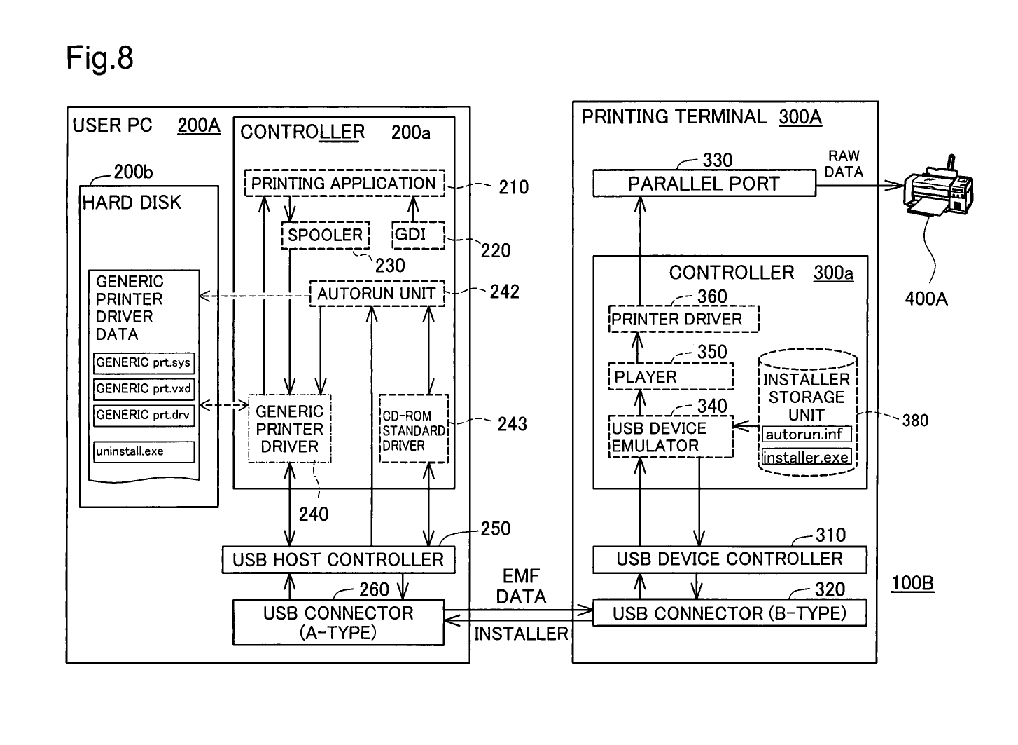

The printing system 100B of a third embodiment will now be described. The basic construction of the printing system 100B of the third embodiment is shown in FIG. 8. As shown in the drawing, the printing system 100B of the third embodiment is identical to the printing system of the second embodiment except for that it expressly includes a hard disk 200b. This hard disk 200b stores various types of data including command code data for the software installed on the user PC 200A.

In the third embodiment, the controller 200a of the user PC 200A realizes each of the various function blocks by retrieving the software stored on the hard disk 200b into memory (RAM).

In the third embodiment, as in the second embodiment, the installer storage unit 380 stores the autorun file that is retrieved onto the user PC 200A when the user PC 200A recognizes the printing terminal 300A as a CD-ROM drive device. This autorun file specifies a prescribed installer that is also stored in the installer storage unit 380 as a file to be automatically executed by the user PC 200A. The user PC 200A autorun unit 242 can install the generic printer driver 240 on the user PC 200A using this installer. Specifically, the autorun unit 242 stores the command code data and other data for the generic printer driver 240 in a prescribed area of the hard disk 200b. As one example of the data stored on the hard disk 200b, FIG. 8 shows the data for the generic printer driver 240 stored on the hard disk 200b through the installation of the generic printer driver 240. The data for the generic printer driver 240 includes the execution file for the uninstaller for the generic printer driver 240 itself. ‘Uninstaller.exe’ in FIG. 8 is an example of an uninstaller stored on the hard disk 200b. The generic printer driver 240 can uninstall itself by booting the uninstaller stored on the hard disk 200b.

In the third embodiment, when the generic printer driver 240 detects that the printing terminal 300A has been disconnected from the user PC 200A, it stops providing the original functions of the printer driver and boots the generic printer driver 240 uninstaller. The generic printer driver 240 uninstaller (represented as luninstaller.exel in FIG. 8) is stored on the hard disk 200b as a part of the data for the generic printer driver 240. The controller 200a retrieves the uninstaller stored on the hard disk 200b into the RAM of the controller 200a and boots it. The uninstaller uninstalls the generic printer driver 240 via operation within the RAM of the controller 200a and deletes the data for the generic printer driver 240 from the hard disk 200b together with the data for the uninstaller itself.

Space is thereby made available on the hard disk 200b on which the data for the generic printer driver 240 was stored, enabling such space to be used for the storage of other data. The user PC 200A then ends processing after the uninstall process is completed.

### J. Operation and Effect of Third Embodiment

According to the above embodiment, because the uninstall process is carried out automatically as described above, the generic printer driver 240 can be automatically uninstalled when the printer 400A is no longer being used. As a result, the amount of data stored on the hard disk 200b of the user PC 200A can be reduced. Furthermore, such uninstallation may improve the processing efficiency of the user PC 200A.

In step Sa13 in FIG. 7, the data for the generic printer driver 240 need not be deleted completely from the hard disk 200b. For example, the data for the generic printer driver 240 stored on the hard disk 200b may be simply compressed.

In the above embodiment, the generic printer driver 240 itself uninstalled the generic printer driver 240, but the present invention is not limited to this implementation. For example, the OS installed on the user PC 200A may uninstall the generic printer driver 240. Alternatively, the uninstaller may be separately installed on the user PC 200A along with the generic printer driver 240.

In the embodiment, the generic printer driver 240 was automatically installed on the user PC 200A (steps Sa2-Sa7, Sb1-Sb3 in FIG. 7), but the present invention is not limited to this implementation. For example, the user PC 200A may be shipped from the factory with the generic printer driver 240 pre-installed.

The processing of the second and third embodiments can be performed using a networked conversion server 600, as in the first embodiment (see FIG. 5). Furthermore, the various modifications implemented in connection with the first embodiment may be implemented with the second and third embodiments as well.

In the above embodiment, one or more of the functions realized by the printing terminal 300A may be achieved using a different construction. For example, the printing terminal may be made to comprise a peripheral device that has the functions of the printing terminal of the embodiment except for the function of mediation and relay to the printing device and that automatically installs various types of software on the user PC 200A via execution of the steps Sb1-Sb3 shown in FIG. 7. In this way, a software supply device may be realized in which various types of software are stored and using which any software desired by the user can be easily installed.

In the above embodiment, the CD-ROM drive function and the print data mediation/relay function are provided in sequence via the switching of configuration information as shown in connection with steps Sb1 and Sb4 in FIG. 7. In the present invention, the functions sequentially provided need not include the CD-ROM drive function. For example, the configuration information may be switched such that the function to cause the print terminal to be recognized as a scanner is followed by the function to cause the print terminal to be recognized as a printer. This would enable the equivalent of MFP functions to be easily provided by connecting the printer 400A and a scanner to the printing terminal 300A. Moreover, because the printer driver configuration window can be automatically displayed on the user PC 200A when scanning by the scanner is completed, the user can easily use the needed function according to a prescribed sequence without paying attention to function switching.

While several embodiments of the above invention were described above, the scope of the present invention is defined only by the claims, and is not limited in any way by the embodiments. The present invention may naturally be implemented in various other ways in addition to those described by the embodiments.

1. A printing terminal connected to a printer, the terminal comprising:
a connection port that is used to locally connect a printing data outputting device that outputs print data;
an input unit that inputs from the printing data outputting device via the connection port first print data in which printing contents are stored using printer-independent generic draw format;
a converter that converts the first print data into second print data that is interpreted by the printer; and
an output unit that outputs the second print data to the printer.

2. The printing terminal according to claim 1, wherein the connection port is a swappable under a using condition.

3. The printing terminal according to claim 1, wherein the terminal further comprises a notification unit that, where the printing data outputting device is connected to the connection port, notifies the printing data outputting device that the printing terminal is the output destination for the first print data.

4. The printing terminal according to claim 1, wherein the output unit outputs the second print data over a network to the printer set in advance as an output destination.

5. The printing terminal according to claim 1, the terminal further comprising a characteristic data output unit that outputs characteristic data indicating prescribed characteristics of the printer to the print data output unit before the first data is input via the connector.

6. The printing terminal according to claim 1,
wherein the printing terminal is configured on a computer, and
the converter comprises an application program that reproduces the print contents based on the draw format stored in the first print data and a printer driver that generates the second print data based on the reproduced print data in accordance with a print instruction issued from the application program.

7. The printing terminal according to claim 6,
wherein the printing data outputting device is configured on a computer, and
the printer driver is installed on the printing data outputting device when the printing data outputting device were connected directly to the printer.

8. A printing data outputting device that outputs print data to a printing terminal connected to a printer, the device compriseing:
a characteristic data input unit that inputs from the printing terminal characteristic data indicating prescribed characteristic data pertaining to the printer;
a print data generator that generates in response to the characteristic data print data in which print contents are stored using printer-independent generic draw format; and
an output unit that outputs the generated print data to the print terminal.

9. A printing method for printing by using a printing terminal that is connected to a printer, the printing terminal comprising a connection port that enables a local connection to a printing data outputting device that outputs print data, the printing method comprising:
inputting from the printing data outputting device via the connection port first print data in which printing contents are stored using printer-independent generic draw format;
converting the first print data into second print data that is interpreted by the printer; and
outputting the second print data to the printer.

10. A computer program that enables a printing terminal connected to a printer to execute printing, the printing terminal comprising a connection port that enables a printing data outputting device that outputs print data to be locally connected and the computer program realizing on a computer the functions of:
inputting from the printing data outputting device via the connection port first print data in which printing contents are stored using printer-independent generic draw format;
converting the first print data into second print data that is interpreted by the printer; and
outputting the second print data to the printer.

11. A computer program using which a printing data outputting device outputs print data to a printing terminal connected to a printer, the computer program realizing on a computer the functions of:
inputting from the printing terminal characteristic data that indicates prescribed characteristics of the printer;
generating in response to the characteristic data print data in which print contents are stored using printer-independent generic draw format; and
outputting the generated print data to the print terminal.

12. A computer-readable recording medium on which the computer program according to claim 10 or 11 is recorded.

13. A peripheral device that is connected locally to the connection port of a computer having a function of automatically executing a file stored in a prescribed area of a specific type of device when the device is connected to the computer, wherein the peripheral device is different from the specific type of device, the peripheral device comprises:
a signal output unit that, when the peripheral device is connected to the connection port of the computer, outputs to the computer an identification signal that causes the peripheral device to be recognized as the specific type of device; and
a storage function unit that stores the file to be executed by the computer,
wherein the file comprises an installer for program used by the computer to output print data.

14. The peripheral device according to claim 13, wherein the connection port is swappable under a using condition.

15. The peripheral device according to claim 13, wherein the signal output unit outputs an identification signal that, where the program is retrieved by the computer, causes the peripheral device to be recognized as a prescribed device to receive the print data, and the peripheral device further includes a relay function unit that relays the print data output by the computer to a prescribed printing device connected to the peripheral device.

16. The peripheral device according to claim 15, wherein the signal output unit outputs an identification signal that causes the peripheral device to be recognized as a prescribed device to receive the print data, after issuing from the computer a notification indicating that the program installation has been completed.

17. A peripheral device that is connected locally to the connection port of a computer, the peripheral device comprising:
a plural of function supply units that, when the peripheral device is connected to the computer, enable the peripheral device to function as a specific type of device;
a switching controller that provides a plural of functions to the computer by switching, according to a prescribed sequence, among identification signals that cause the computer to recognize that a specific type of device is connected,
wherein one of the functions is install program used by the computer to output print data.

18. The peripheral device according to claim 17, wherein the switching controller controls the output signals sent to the connection port such that during the process of switching among the functions, the computer is caused to recognize that the connection is terminated once and re-established.

19. The peripheral device according to claim 17, wherein the computer has a function to automatically execute a file stored in a prescribed area of the device when a specific type of device is connected to the connection port,
the peripheral device further comprising:
a first function supply unit that stores a program that installs program used by the computer to output print data and sends this installer program to the computer as the file to be executed; and
a second function supply unit that obtains print data output by the computer and causes printing to be performed by a prescribed printing device in accordance with this data, and
wherein the switching controller sends an identification signal that causes the peripheral device to be recognized as a prescribed device to receive the print data.

20. The peripheral device according to claim 17, wherein the switching controller performs the switching in response to a prescribed notification from the computer.

21. A control method for controlling a peripheral device that is locally connected to the connection port of a computer having a function to automatically execute a file stored in a prescribed area of a specific type of device when the specific type of device is connected to the computer, the peripheral device being of a type different from the specific type of device, the control method comprising:
storing the file to be executed in the peripheral device;
outputting an identification signal that causes the peripheral device to be recognized as the specific type of device to the computer when the peripheral device is connected to the connection port; and
installing a program to output print data on the computer via the execution of the stored file.

22. A control method for a peripheral device that is locally connected to the connection port of a computer, the method comprising the peripheral device to function as a specific type of device when it is connected to the computer,
the control method comprising:
providing a plural of functions to the computer by switching among identification signals that cause the computer to recognize that a specific type of device has been connected; and
installing a program used by the computer to output print data.

23. A computer program executed in a peripheral device when the peripheral device is locally connected to the connection port of a computer having a function to automatically execute a file stored in a prescribed area of a specific type of device when the specific type of device is connected to the computer, the peripheral device being of a type different from the specific type of device, the computer program product comprising:
a function to output to the computer an identification signal that cause the peripheral device to recognize the peripheral device as the specific type of device when the peripheral device is connected to the connection port; and
a function to execute a program to install a program code to output print data on the computer, in response to control by the computer that receives the identification signal, the program is stored on the peripheral device as a file.

24. A computer program that controls a peripheral device that is locally connected to the connection port of a computer, the program realizing on the computer the functions of:
detecting the switching sequence according to a prescribed order among identification signals output from the peripheral device in order to cause the computer to recognize that a specific type of device has been connected to the connection port; and
recognizing the peripheral device as a specific type of device in accordance with the switching sequence and executing a plural of preset operations for each type of device when the switching is detected,
wherein one of the operations installs a program used by the computer to output print data.

25. A computer-readable recording medium on which the computer program according to claim 23 or 24 is recorded.

26. A computer program that uninstalls a program that was installed on a computer to enable the use of a peripheral device when the peripheral device is locally connected to the computer, the computer program realizing on the computer the functions of:
detecting that the local connection between the peripheral device and the computer has been terminated: and
executing a program to uninstall from the computer the installed program in response to the detection.

27. The computer program according to claim 26, wherein the program that carries out the uninstall process is realized in part by the program.

28. The computer program according to claim 26, wherein the program realizing on the computer a function to switch between executing or not executing the uninstall program based on a prescribed condition.

29. A computer-readable recording medium on which the computer program according to any of claims 26 through 28 is recorded.

30. A method for uninstalling program that was installed on a computer in order to enable the use of a peripheral device when the peripheral device is connected locally to the computer, the method comprising:
detecting that the local connection between the peripheral device and the computer has been terminated; and
uninstalling from the computer the installed program in response to this detection.

31. A computer having a connection port that locally connects a peripheral device to the computer, the computer comprising:
a storage unit that stores a program installed on the computer in order to enable the use of the peripheral device when the peripheral device is connected to the connection port;
a detection unit that detects that the peripheral device has been disconnected from the connection port; and
an uninstall unit that uninstalls the program stored in the storage unit in response to this detection.
